(19) United States
(12) Patent Application Publication
(10) Pub. No.: US 2023/0026992 A1
(43) Pub. Date: Jan. 26, 2023

(54) THROTTLE WITH INTEGRATED SWITCH BLOCK

(71) Applicant: HIRSCHMANN AUTOMOTIVE GMBH, Rankweil/Brederis (AT)

(72) Inventors: Thomas GROHS, Tschagguns (AT); Dietmar MAEHR, Duens (AT); Michael PRIMOSCH, Feldkirch (AT)

(21) Appl. No.: 17/783,555

(22) PCT Filed: Dec. 10, 2020
(86) PCT No.: PCT/EP2020/085584

§ 371 Date: Jun. 8, 2022

(30) Foreign Application Priority Data
Dec. 10, 2019 (DE) 10 2019 133 710.0

(51) Int. Cl. B62K 23/04; B62J 45/413; B62J 45/422

(52) U.S. Cl. CPC B62K 23/04; B62J 45/413; B62J 45/422

(57) ABSTRACT

The invention relates to a manual throttle twist grip having a sensor arrangement, mounted in a housing (2), for detecting the rotary motion of a tubular twist grip (1), having a magnet (6) which is operatively connected to the twist grip (1), having a sensor (11) fixed to the housing and designed to detect the motion of the magnet (6), wherein the sensor (11) is connected to a cable harness (10), and having a return spring, the spring force of which is directed against the manually generated rotary motion, wherein the magnet (6) is fixed to a support element (5) and the support element (5) is arranged at a distance from the twist grip (1), wherein a housing part (7) is associated with the magnet (6) and the support element (5) and wherein said housing part (7) is also used for receiving the sensor (11), a circuit board (9) and the end of the cable harness (10).

The invention relates to a hand-operated rotary throttle having a sensor mounted in a housing for detecting rotation of a tubular twist grip, having a magnet that is operatively connected to the twist grip, having a sensor that is fixed to the housing and is designed to detect movement of the magnet, the sensor being connected to a cable harness, and a restoring spring whose spring force is directed counter to rotation generated by a hand according to the features of the preamble of patent claim 1.

A throttle of this type is known from EP 2 507 592 (US 2012/0242331). In this case, the components are designed in such a way that they are joined together in the axial direction of the twist grip and have correspondingly oriented joints. It has been found that the short structural space that adjoins the twist grip, is not sufficient to accommodate the required components, for example the sensor and a shield, as well as a switch, in an operationally safe manner protected from the environment.

The object of the invention is therefore to improve a hand-operated rotary throttle of the type described above such that sufficient installation space is available in the provided housing, which installation space can be created in a simple manner to protect against environmental influences.

This object is achieved by the features of claim 1.

According to the invention, the magnet is fixed to a support spaced from the twist grip, that a main housing part is associated with the magnet or the support and that this main housing part holds the sensor, a printed-circuit board and the end of the cable harness.

Furthermore, it is proposed that an additional housing part that holds a switch is provided between the main housing part and the end of the twist grip. As a result, the switch is adjacent the twist grip for easy hand operation. The main housing part and the additional housing part are embodied in one piece as seen in the axial direction of the twist grip. This configuration provides with the required measurements sufficient installation space that can be well sealed and protected.

Furthermore, it is proposed that the housing with the main housing part and the additional housing part are separated at a plane parallel to the axis of rotation of the twist grip and can be fastened to one another. As a result, the upper housing part, the housing part, and the additional housing part are made as one piece.

Furthermore, it is proposed that the sensor is on the printed-circuit board and that the housing part and/or the additional housing part has a radial extension with an axially accessible opening in the region of the housing lower part that is likewise all one piece. This radial extension is on the underside of the twist grip and is thus protected. The radial extension preferably has guides for holding the printed-circuit board and, if appropriate, a shield, and the end of the cable harness also lies therein for accommodating radial expansion. The opening of the radial extension can be closed by a seal.

As a further embodiment of the invention, reference is made to the drawings in which an embodiment of the invention is illustrated. Therein:

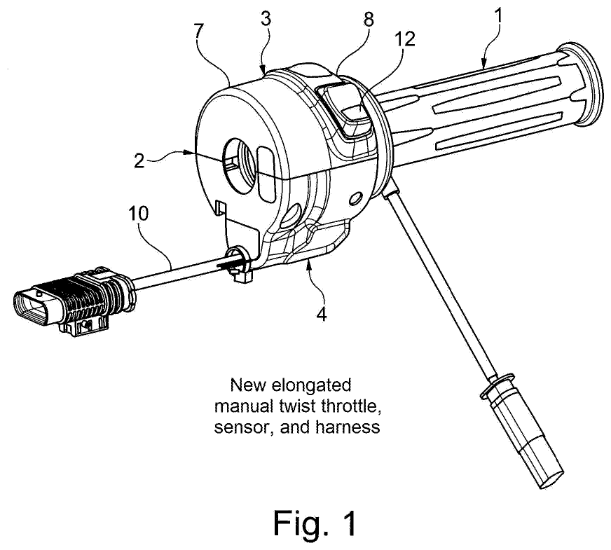

FIG. 1 shows a perspective complete view of a flange rotary throttle in an end position,

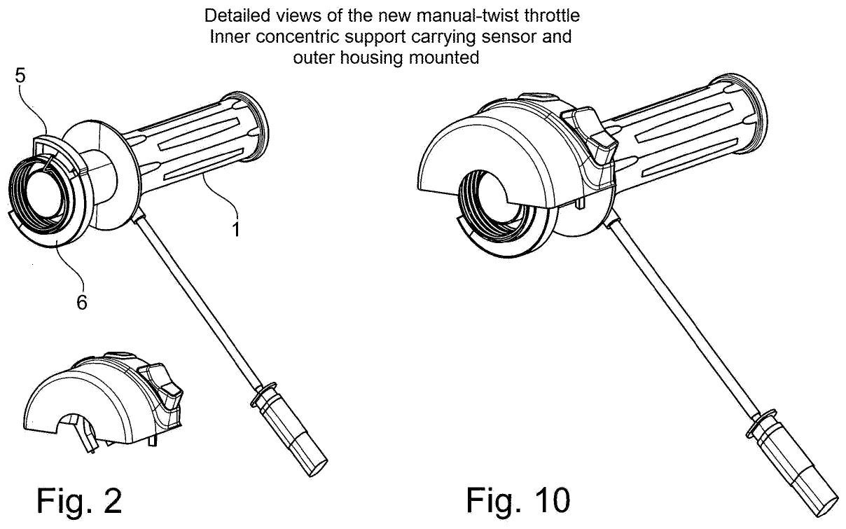

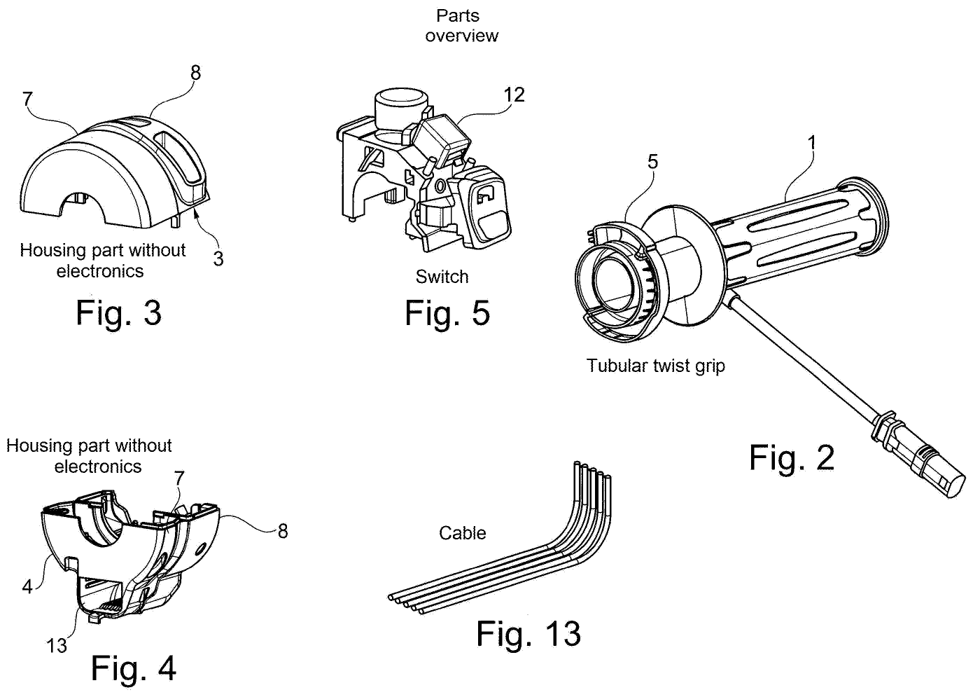

FIG. 2 shows a twist grip as individual components with a mounted support and magnets,

FIG. 3 shows a detail view of a housing upper part,

FIG. 4 shows a detail view of a lower housing part,

FIG. 5 shows a detail view of a switch,

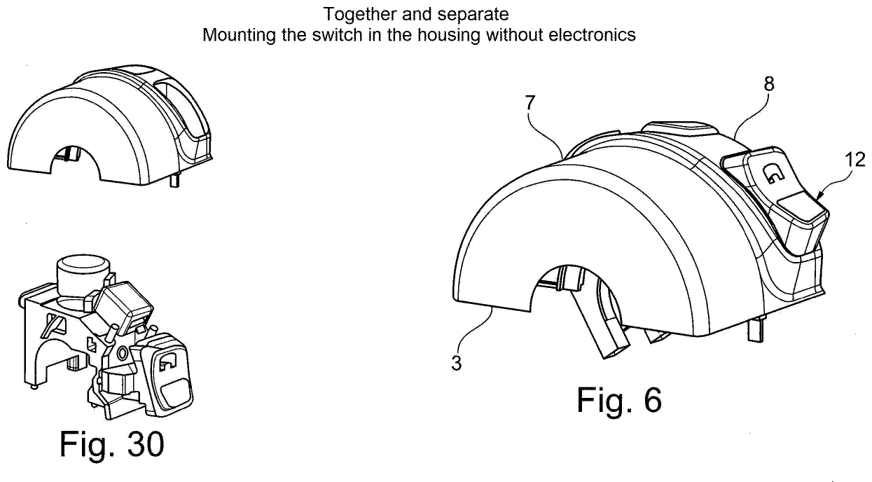

FIG. 6 shows a detail view of an upper housing part with a built-in switch,

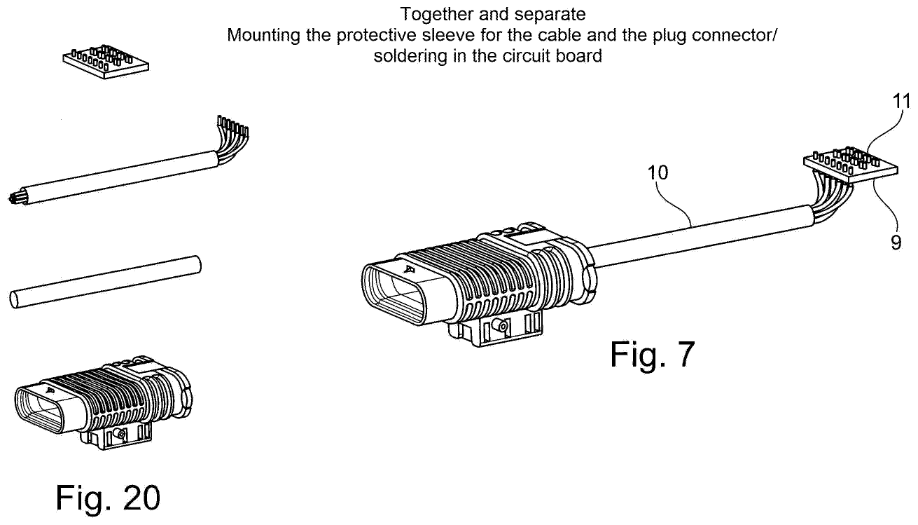

FIG. 7 shows a wiring harness with soldered printed-circuit board, and

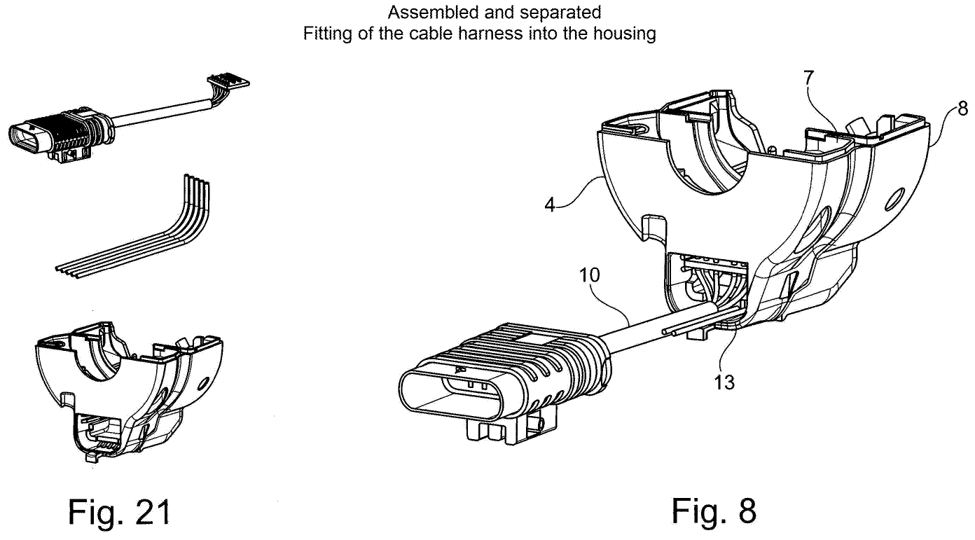

FIG. 8 shows a lower housing part as an individual component with a built-in printed-circuit board and harness end.

For the sake of better understanding, FIGS. 1 to 8 are provided with reference numerals and are explained in detail below.

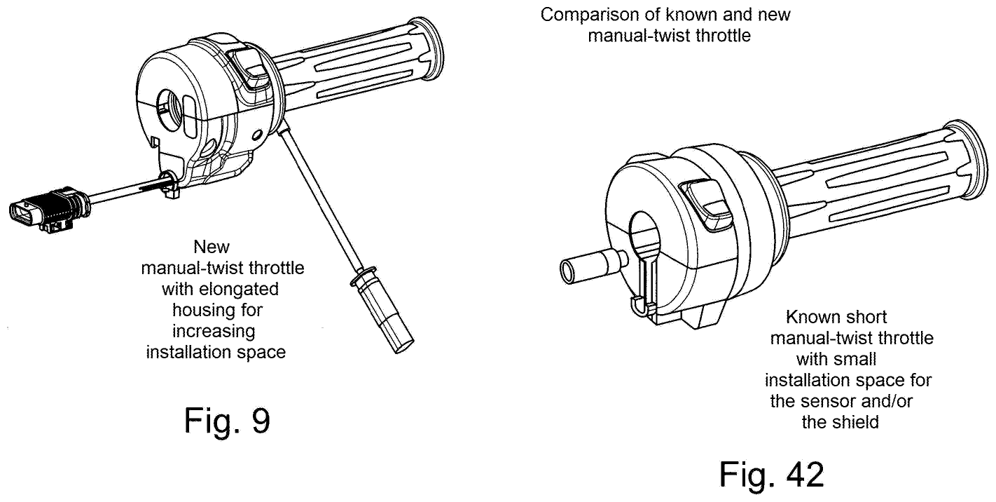

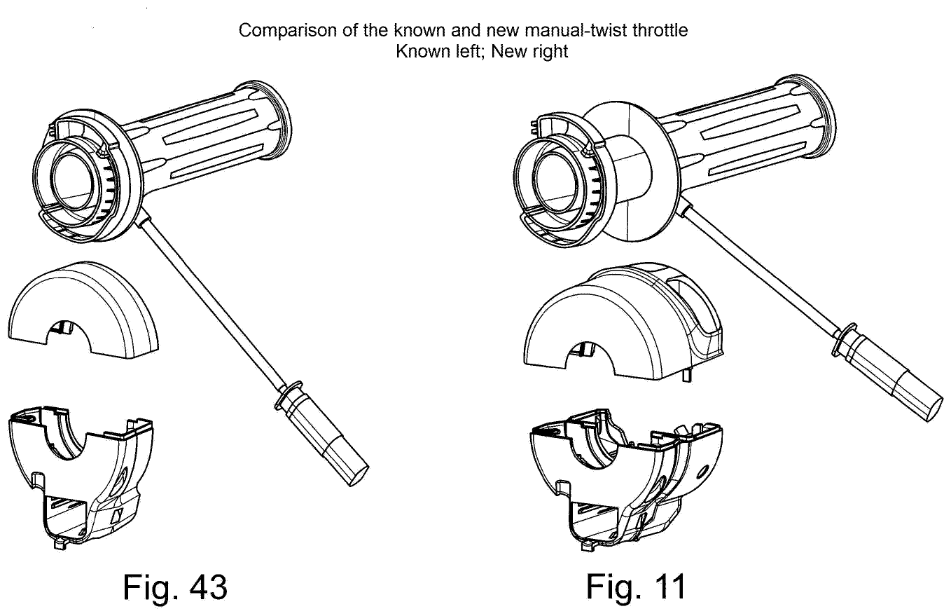

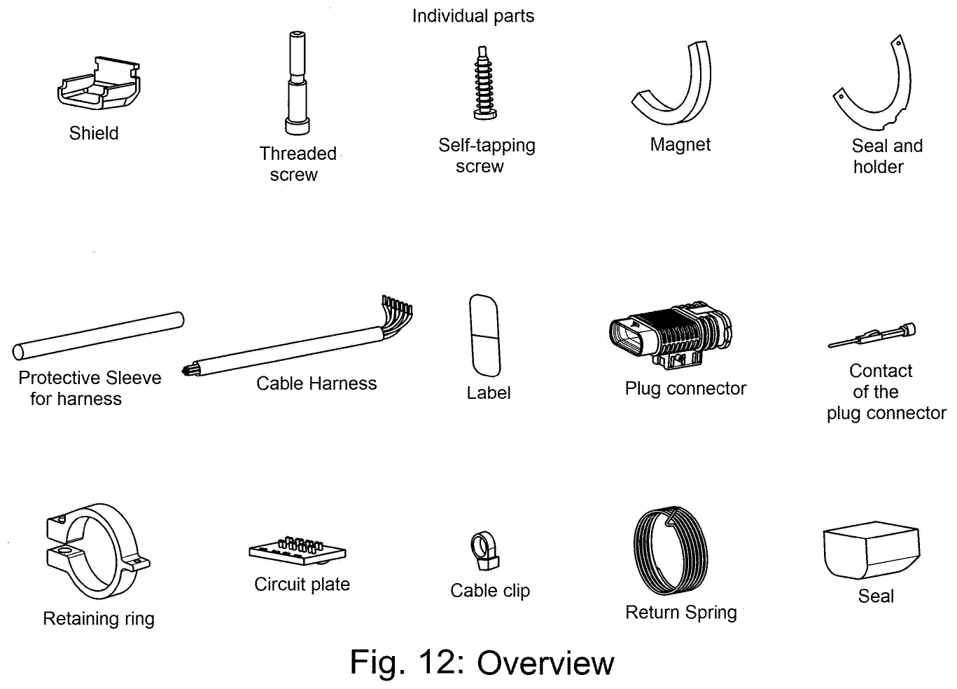

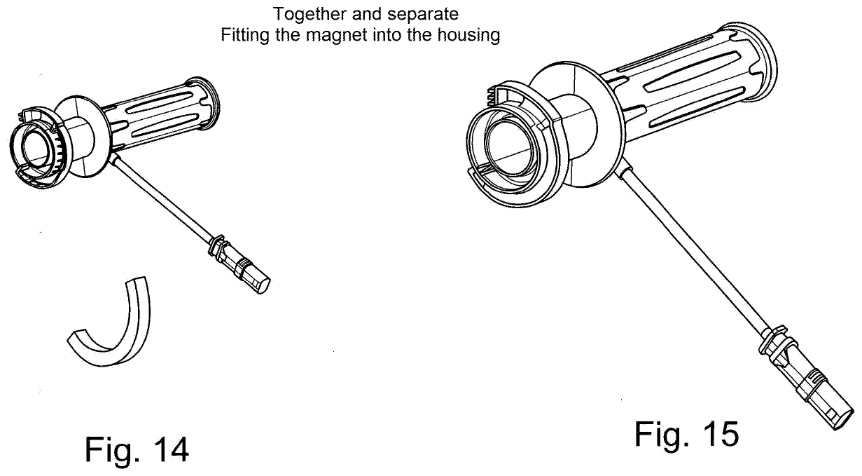

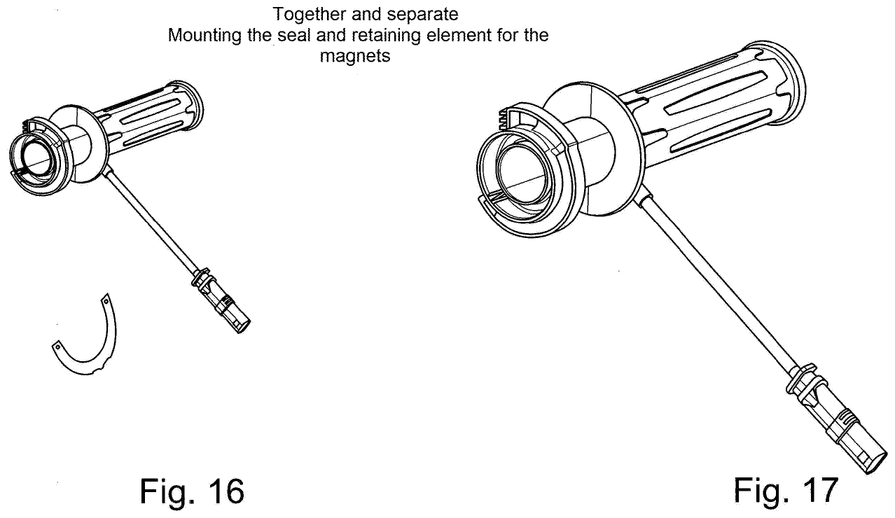

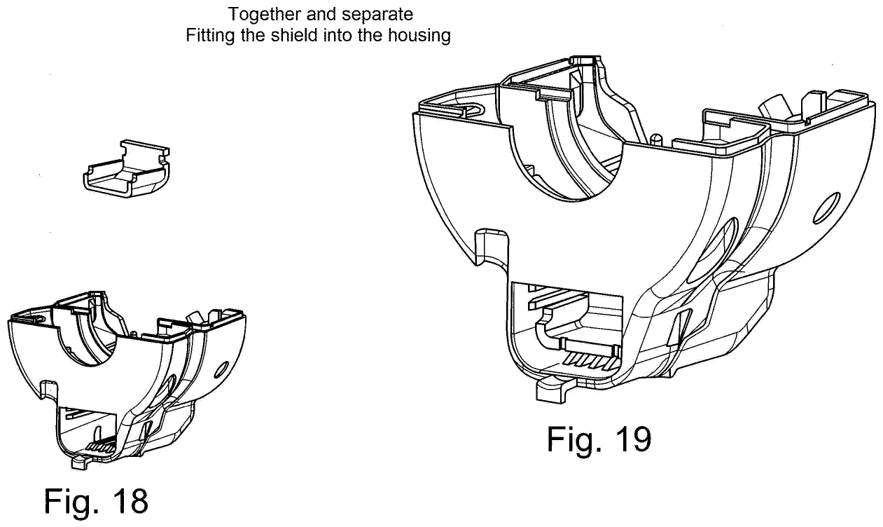

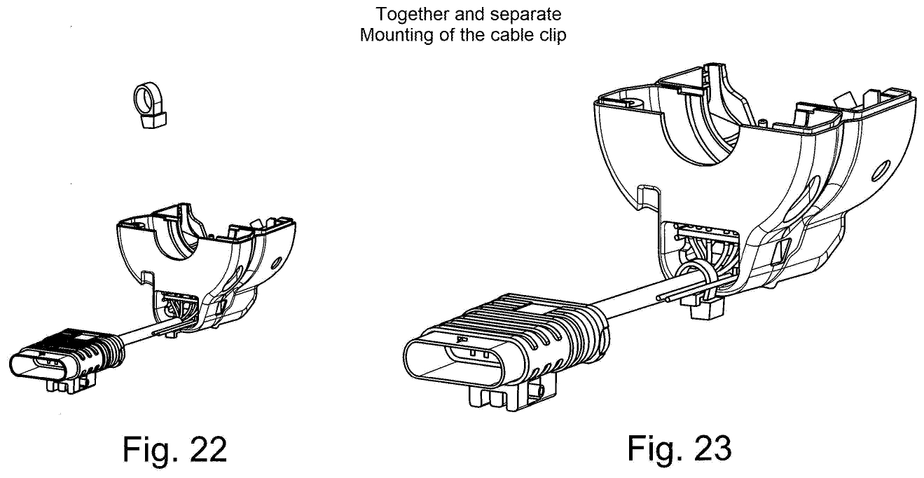

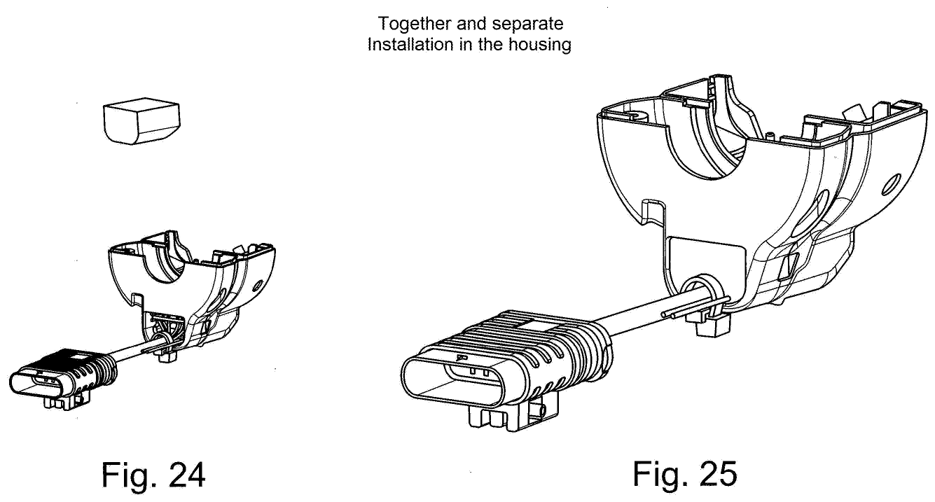

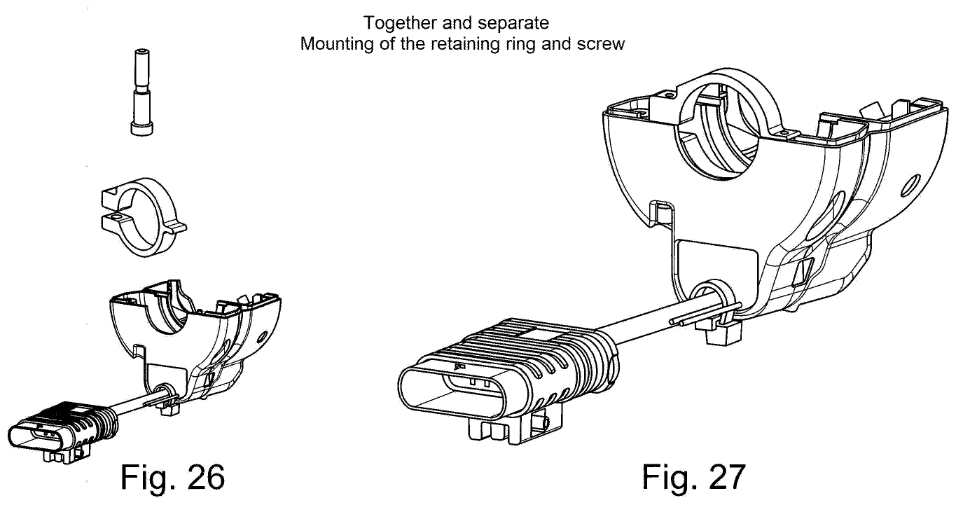

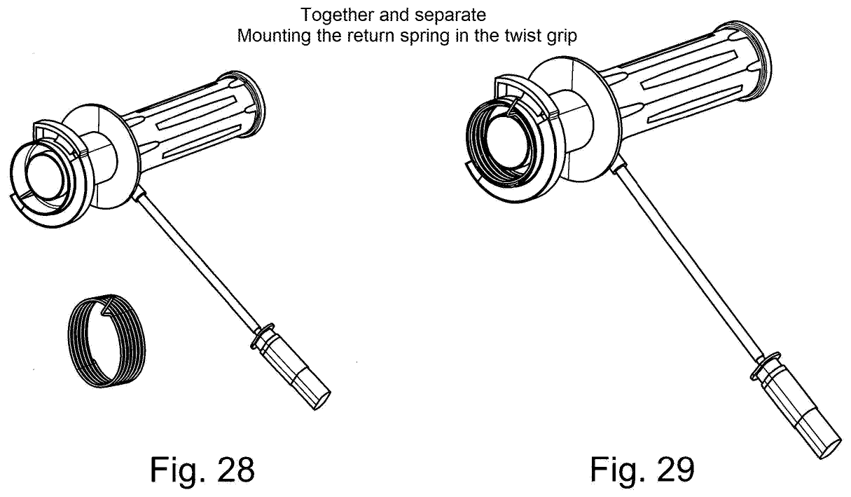

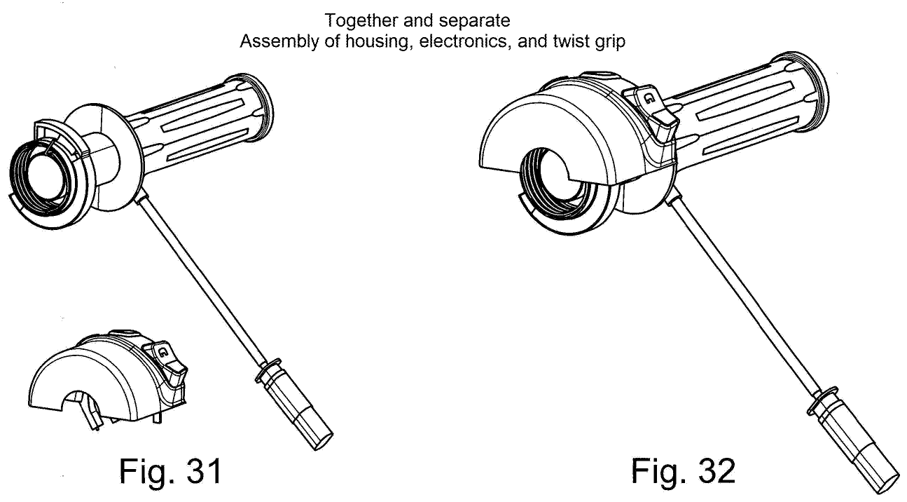

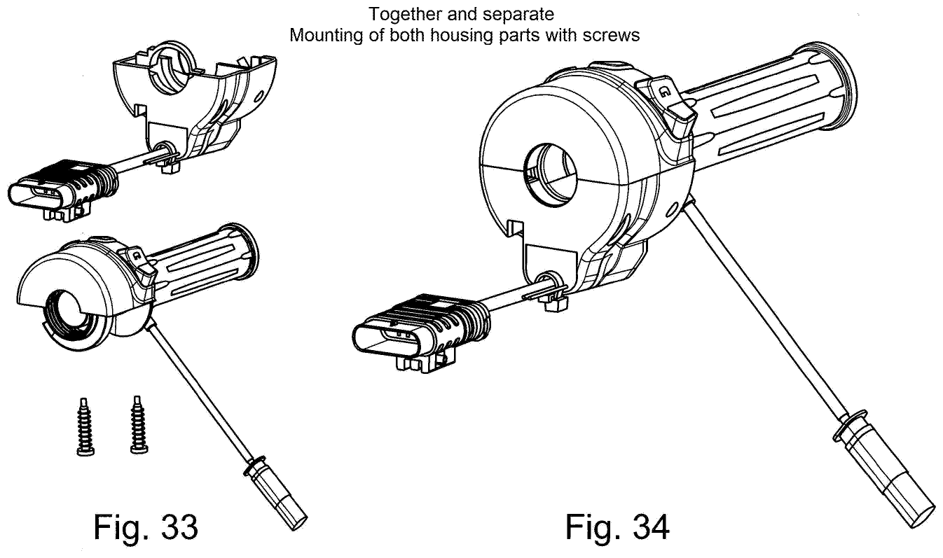

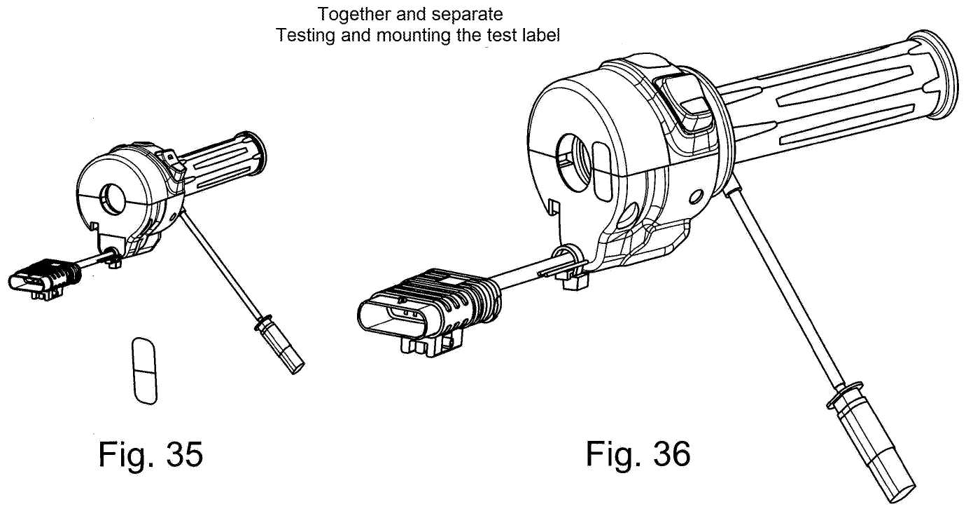

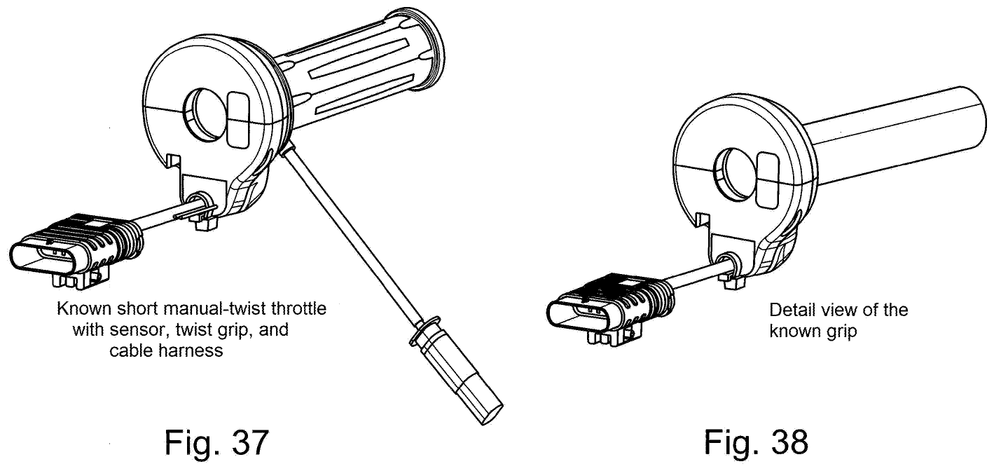

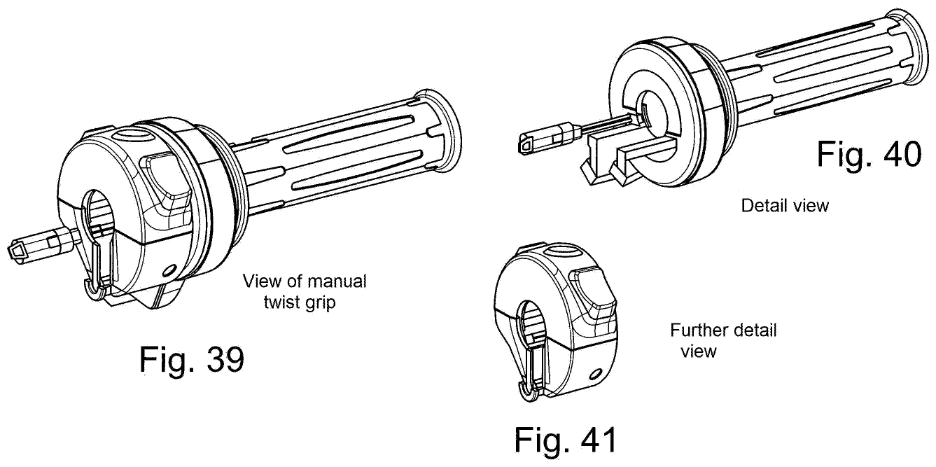

In addition, FIGS. 9 to 36 show the rotary grip (flange rotary throttle) according to the invention in further detail (without reference numerals) and steps of assembly and an overview of the required elements of the twist grip (FIG. 12). FIGS. 37 to 42 show a twist grip according to the prior art.

Referring to FIGS. 1 to 8, reference 1 designates a (manually operable) twist grip to which is connected a housing 2 holding a sensor assembly. The housing 2 is divided into an upper part 3 and a lower part 4 that can be screwed together.

As can be seen in particular from FIG. 2, the tubular twist grip 1 is extended and has, at its end, a support 5 that is of circular arc-shaped design and to which a magnet 6 is fastened. The housing 2 with the upper housing part 3 and the lower housing part 4 is divided along the axis of the twist grip 1 into a main housing part 7 and an additional housing part 8.

The main housing part 7 holds the support 5 with the magnet 6 and a printed-circuit board 9 that is connected to the end of a cable harness 10. The printed-circuit board 9 also includes a sensor 11 and is held inside the main housing part 7 such that the sensor 11 is operatively connected to the magnet 6. A switch 12 shown in FIG. 5 is installed in the additional housing part 8. As in particular in FIGS. 3, 4, 6 and 8 the main housing part 7 and the additional housing part 8 are separated from one another by an intermediate wall.

The lower housing part 4 has a radial extension 13 in formed with guides 14. The guides 14 hold the printed-circuit board 9 and a shield. Viewed axially of the twist grip 1, the radial extension extends at least as far as the end of the main housing part 7 and has an axial opening 15 that can be closed by a seal.

With regard to further details and the steps of assembling the participating elements, reference is made to the remaining associated figures.

LIST OF REFERENCES

| | |
|---|---|
| 1 | Twist grip |
| 2 | Housing |
| 3 | Upper housing part |
| 4 | Lower part of the housing |
| 5 | Support |
| 6 | Magnet |
| 7 | Main housing part |
| 8 | Additional housing part |
| 9 | Printed-circuit board |
| 10 | Wiring harness |
| 11 | Sensor |
| 12 | Switch unit |
| 13 | Radial expansion |
| 14 | Guide element |
| 15 | Opening |

1. A rotary throttle comprising:
a cable harness;
a printed-circuit board;
a main housing part forming a support;
a hand-operable tubular twist grip rotatable about an axis on the housing;
a sensor mounted in the main housing part for detecting manual rotation of the twist grip;
a magnet operatively connected to the twist grip, the sensor being fixed to the main housing part, serving to detect movement of the magnet, and being connected via the printed-circuit board to the cable harness; and
a return spring applying to the twist grip a spring force counter to rotation generated by a hand rotating the twist grip, the magnet being fixed to the support spaced from the twist grip, the main housing part being juxtaposed with the magnet or the support and also holding the sensor, a printed-circuit board and an end of a cable harness.

2. The rotary throttle according to claim 1, further comprising:
an additional housing part between the main housing part and an end of the rotary twist grip, the additional housing part holding a switch assembly.

3. The rotary throttle according to claim 2, wherein the main housing part and the additional part are joined together parallel to an axis of rotation of the twist grip into a housing upper part and a lower housing part fastenable to each other.

4. The rotary throttle according to claim 1, wherein the sensor is on the printed-circuit board.

5. The rotary throttle according to claim 3, wherein the main housing part or the additional housing part has on the lower housing part a radial extension with an axially accessible opening.

6. The rotary throttle according to claim 1, wherein the radial extension has guides receiving the printed-circuit board and a shield.

7. The rotary throttle according to claim 5, further comprising:
a seal closing the opening.
